(19) United States
(12) Patent Application Publication
(10) Pub. No.: US 2018/0129102 A1
(43) Pub. Date: May 10, 2018

(54) LIQUID CRYSTAL DISPLAY DEVICE AND METHOD OF PRODUCING LIQUID CRYSTAL DISPLAY DEVICE

(71) Applicant: SHARP KABUSHIKI KAISHA, Sakai City, Osaka (JP)

(72) Inventor: KAZUYA MURAKAMI, Sakai City (JP)

(73) Assignee: Sharp Kabushiki Kaisha, Osaka (JP)

(21) Appl. No.: 15/564,244

(22) PCT Filed: Mar. 30, 2016
(86) PCT No.: PCT/JP2016/060290

§ 371 Date: Oct. 4, 2017

(30) Foreign Application Priority Data
Apr. 6, 2015 (JP) 2015-077856

(51) Int. Cl. G02F 1/1335; G02F 1/1333

(52) U.S. Cl. CPC G02F 1/133608; G02F 1/133308

(57) ABSTRACT

The present invention provides a liquid crystal display device which suppresses deflection of the liquid crystal panel and thus enhances display performance. The liquid crystal display device of the present invention includes a liquid crystal panel; and a backlight unit including a backlight and a housing holding the backlight, the backlight being positioned on the back face side of the liquid crystal panel such that the backlight does not make contact with the liquid crystal panel and overlaps the liquid crystal panel in a plan view, the housing including a side wall, the side wall surrounding the liquid crystal panel in a plan view, at least part of an edge of the liquid crystal panel arid at least part of the side wall of the housing being adhesively secured to each other with a cured resin.

### TECHNICAL FIELD

The present invention relates to liquid crystal display devices and methods of producing liquid crystal display devices. In particular, the present invention relates to a liquid crystal display device having a specific structure suitable for in-plane switching (IPS) mode liquid crystal display devices and a method of producing the liquid crystal display device.

### BACKGROUND ART

Liquid crystal display devices include a liquid crystal panel composed of a liquid crystal layer disposed between paired substrates such as glass substrates and a backlight disposed on the back side of the liquid crystal panel. The devices nave characteristics such as a thin profile, lightweight, and low power consumption. These characteristics have made the devices essential to products used in daily life and business, including automotive navigation systems, electronic books, digital photo frames, industrial equipment, televisions, personal computers, smartphones, and tablet computers.

Liquid crystal display devices have been previously disclosed. For example, Patent Literature 1 discloses a liquid crystal display device including a structure, wherein the structure is positioned facing the display side of a liquid crystal display element at a distance equal to or smaller than a predetermined gap and is supported by a supporting frame of a backlight unit.

### CITATION LIST

### Patent Literature

Patent Literature 1: JP 2010-237493 A

### SUMMARY OF INVENTION

### Technical problem

FIG. 11 is a basic configuration diagram (cross-sectional view) of a current liquid crystal panel. Currently, a liquid crystal panel is secured with double-sided tape 766 to a side wall (backlight frame) 760F of a housing holding a backlight. If the side wall 760F of the housing has a low flatness (has deflection), the liquid crystal panel 740 is deflected, causing light leakage in black display and thus reducing the contrast. Especially in IPS mode liquid crystal panels, even a slight deflection (about 0.1 mm) causes light leakage in black display and reduces the contrast. (For example, when the liquid crystal panel in FIG. 13 in black display is distorted and deflected by hand, the screen partially turns white as in the liquid crystal panel in FIG. 14.)

In the liquid crystal display device disclosed in Patent Literature 1, a decorative plate (protective plate) bonded to the display side of the liquid crystal panel and the side wall of the housing are secured to each other with double-sided tape, so that external force applied to the decorative plate is transmitted not only to the liquid crystal panel but also to the side wall of the housing, and the external force can be dispersed (for example, FIG. 1 of Patent Literature 1). This configuration suppresses reduction in display performance. However, also in the liquid crystal display device disclosed in Patent Literature 1, a low flatness and deflection of the side wall of the housing will result in distortion of the liquid crystal panel. The liquid crystal display device of Patent Literature 1 thus also has room for improvement to prevent reduction in the display performance.

The present invention is made in view of the situation in the art. The present invention aims to provide a liquid crystal display device which suppresses the deflection of the liquid crystal panel and thus exhibits an enhanced display performance.

### Solution to Problem

The present inventors studied various liquid crystal display devices capable of suppressing the deflection of the liquid crystal panel. They focused on securing the liquid crystal panel to the side wall of the housing with an adhesive resin, instead of double-sided tape, so as to moderate stress transmitted from, the backlight to the liquid crystal panel. Furthermore, they arrived at the idea of pouring a fluid resin to adhesively secure the edge of the liquid crystal panel to the side wall of the housing holding the backlight while securing the liquid crystal panel away from the backlight with a jig or the like so as not to bring the liquid crystal panel into contact with the backlight (and the housing holding the backlight). For example, holes are provided in the side face of the side wall of the housing, and the resin is poured through the holes. The resin is received by a groove provided in the side wall of the housing side, simultaneously with being brought into contact with the edge of the liquid crystal panel. By curing the resin, the edge of the liquid crystal panel is suitably adhesively secured to the side wall of the housing (for example, FIG. 1). The present inventors found that the liquid crystal display device obtained in such a manner can suppress transmission of the stress due to the deflection of the side wall of the housing to the liquid crystal panel, thus suppressing the deflection of the liquid crystal panel. They found out that this makes it possible to prevent light leakage in black display to improve the contrast and enhance the display performance especially in TPS mode liquid crystal display devices. They thereby arrived at a solution to the above problem, completing the present invention.

One aspect of the present invention may be a liquid crystal display device including: a liquid crystal panel; and a backlight unit including a backlight and a housing holding the backlight, the backlight being positioned on the back face side of the liquid crystal panel such that the backlight does not make contact with the liquid crystal panel and overlaps the liquid crystal panel in a plan view, the housing including a side wall, the side wall surrounding the liquid crystal panel in a plan view, at least part of an edge of the liquid crystal panel and at least part of the side wall of the housing being adhesively secured to each other with a cured resin.

Another aspect of the present invention may be a method of producing the liquid crystal display device of the present invention, the method including the steps of: while holding a liquid crystal panel and a backlight without bringing the liquid crystal panel and the backlight into contact with each other, disposing an uncured resin between at least part of an edge of the liquid crystal panel and at least part of a side wall of a housing; and curing the resin to adhesively secure the at least part of the edge of the liquid crystal panel and the at least part of the side wall of the housing to each other.

The present invention is described in detail below.

The “at least part of an edge of the liquid crystal panel” may be at least part of the surface consisting of the main faces and the side face(s) of the liquid crystal panel in a region overlapping the frame region surrounding the display portion of the liquid crystal display device.

The “at least part of the side wall of the housing” may be at least part of the surface consisting of the main face(s) and the side face(s) of the side wall of the housing.

The “adhesively secured to each other with a cured resin” means being adhered to a cured resin and held, without any external force applied, at a specific position and in a specific direction in relation to another structural component of the liquid crystal display device bonded with the cured resin.

The “plan view” means a plan view of a main face of the liquid crystal panel.

Preferably, the liquid crystal display device of the present invention further includes a front plate, and at least part of a periphery of the front plate is adhesively secured with the cured resin.

The “at least part of a periphery of the front plate” may be at least part of at least one of the main faces of the front plate in a region overlapping the frame region surrounding the display portion of the liquid crystal display device.

Preferably, in the liquid crystal display device of the present invention, at least part of the side wall of the housing includes a groove, and at least part of the cured resin is contained in the groove.

Preferably, in the liquid crystal display device of the present invention, the side wall of the housing includes a partition wall to partition the groove.

Preferably, in the liquid crystal display device of the present invention, the groove includes a recessed bottom.

Preferably, in the liquid crystal display device of the present invention, part of the edge of the liquid crystal panel and part of the side wall of the housing are adhesively secured to each other with the cured resin, and a cushioning material is disposed between another part of the edge of the liquid crystal panel and part of the housing. In a preferred configuration, for example, among the four sides forming the edge of one of the paired substrates, two sides are adhesively secured with the cured resin to the groove in the two sides of the side wall of the housing that correspond to the two sides of the substrate, and cushioning materials are disposed between the other two sides of the substrate and the respective two sides of the side wall of the housing that correspond to the other two sides of the substrate.

Preferably, in the method of producing the liquid crystal display device of the present invention, the step of disposing the resin includes pouring the resin into a groove provided in at least part of the side wall of the housing via a hole provided in the side wall of the housing.

### Advantageous Effects of Invention

The liquid crystal display device of the present invention suppresses deflection of the liquid crystal panel and thus exhibits an enhanced display performance. The method of producing the liquid crystal display device of the present invention enables simple production of such a liquid crystal display device with an enhanced display performance.

### BRIEF DESCRIPTION OF DRAWINGS

FIG. 1 is a schematic cross-sectional view of a liquid crystal display device of Embodiment 1.

FIG. 2 is a schematic view of a side face and a front face of a backlight unit of the liquid crystal display device of Embodiment 1.

FIG. 3 is a schematic cross-sectional view of a liquid crystal display device of Embodiment 2.

FIG. 4 is a schematic front view of a backlight unit of the liquid crystal display device of Embodiment 2.

FIG. 5 is a schematic cross-sectional view of a liquid crystal display device of Embodiment 3.

FIG. 6 is a schematic cross-sectional view of a liquid crystal display device of a modified example of Embodiment 3.

FIG. 7 is a schematic cross-sectional view of a liquid crystal display device of Embodiment 4.

FIG. 8 is a schematic front view of the liquid crystal display device according to Embodiment 4.

FIG. 9 is a schematic front view of a liquid crystal display device according to a first modified example of Embodiment 4.

FIG. 10 is a schematic front view of a liquid crystal display device according to a second modified example of Embodiment 4.

FIG. 11 is a schematic cross-sectional view of a liquid crystal display device of Comparative Example 1.

FIG. 12 is a schematic front view of the liquid crystal display device of Comparative Example 1.

FIG. 13 is a front photograph of a liquid crystal panel in black display under normal conditions.

FIG. 14 is a front photograph of a liquid crystal panel in black display when deflected by distortion by hand.

### DESCRIPTION OF EMBODIMENTS

The present invention is further described in detail below with reference to embodiments. The present invention, however, is not limited to these embodiments.

The liquid crystal display devices of the embodiments each include a backlight unit. The backlight unit includes a surface-emitting backlight and a housing holding the backlight. The housing holding the backlight includes a frame (side wall) in a frame region surrounding the light source.

### Embodiment 1

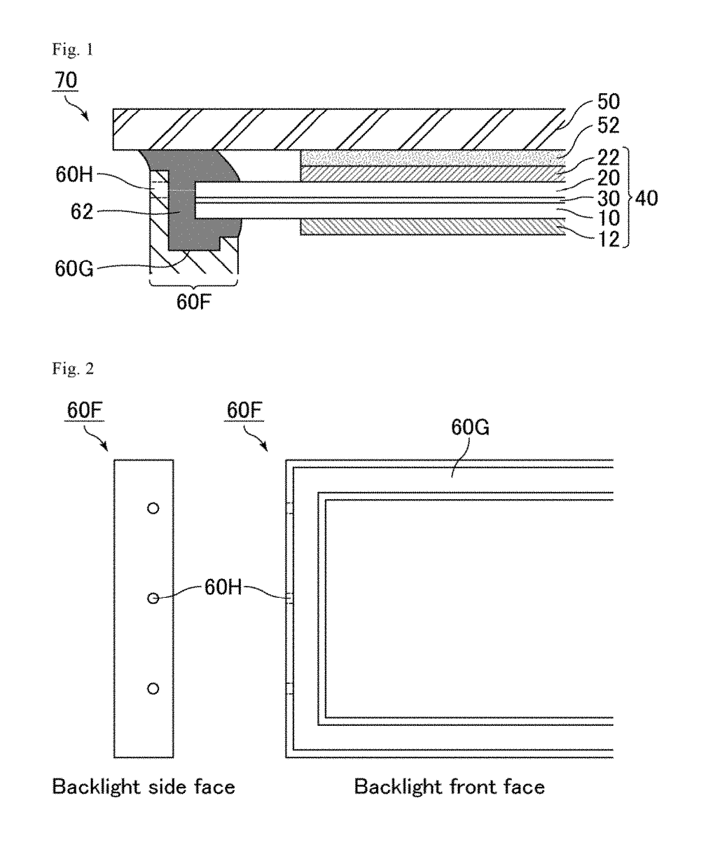

FIG. 1 is a schematic cross-sectional view of a liquid crystal display device of Embodiment 1. In Embodiment 1, the edge of a liquid crystal panel 40 and a side wall 60F of the housing holding the backlight are secured to each other with a cured resin 62. As a result, the edge of the liquid crystal panel 40 is secured to the side wall 60F of the housing without allowing the deflection (e.g., deformation) of the side wall 60F of the housing to affect the liquid crystal panel 40. The minimum distance between the edge of the liquid crystal panel 40 and the side wall 60F of the housing is preferably, for example, 0.1 to 1 mm. This configuration can suppress the deflection of the liquid crystal panel 40 due to the deflection of the side wall 60F of the housing, which prevents light leakage in black display to improve the contrast and enhance the display performance.

In Embodiment 1, the periphery of a front plate 50 held on the front face of the liquid crystal panel is also adhesively secured with the cured resin 62, As a result, external force applied to the front plate 50 can be transmitted not only to the liquid crystal panel 40 but also to the side wall 60F of the housing, and the external force can be dispersed. This configuration can suppress the deflection of the liquid crystal panel 40 due to external force applied to the front plate 50, thus suppressing a reduction in the display performance. The front plate 50 may be, for example, protective glass or a touch panel.

Resins usable as the cured resin include various conventionally known resins that can bond the edge of the liquid crystal panel 40 and the side wall 60F of the housing to each other. Preferred are those curable at room temperature. Examples of resins curable at room temperature include epoxy resin, phenolic resin, and silicone resin.

The liquid crystal panel of Embodiment 1 has a basic structure in which a thin-film transistor element (TFT) substrate 10, a liquid crystal layer 30 containing liquid crystal molecules having a positive anisotropy of dielectric constant or negative anisotropy of dielectric constant, and a CF substrate 20 including a color filter (CF) are arranged in the stated order. Polarizing plates 12 and 22 are disposed on the outer face side of the TFT substrate 10 and the outer face side of the CF substrate 20, respectively. An alignment film may be disposed on the liquid crystal layer side of each of the TFT substrate 10 and the CF substrate 20.

FIG. 2 is a schematic view of a side face and a front face of a backlight unit of the liquid crystal display device of Embodiment 1. A surface-emitting backlight is disposed in the inner portion surrounded by the side wall 60F of the housing.

The side wall 60F of the housing has the following structures (1) and (2).

(1) Groove 60G for holding a resin, provided in all the four sides (periphery) in the front face

(2) Holes 60H for pouring a resin in the side wall 60F of the housing

In a liquid crystal display device 70 of Embodiment 1, in a plan view, the edge of the liquid crystal panel 40 and the edge of the backlight unit (the side wall 60F of the housing) are adhesively secured to each other with the cured resin 62 which continuously surrounds the liquid crystal panel 40. Disposing the cured resin 62 to continuously surround the liquid crystal panel 40 as in Embodiment 1 can further prevent entrance of foreign matter. The edge of the backlight unit (side wall 60F of the housing) includes the groove 60G for holding a resin. Part of the cured resin 62 is contained in the groove 60G for holding a resin.

In Embodiment 1, the groove 60G for holding a resin has a flat bottom. The average depth of the groove 60G for holding a resin is preferably, for example, 100 to 500 μm.

The backlight may be either a direct backlight or an edge light. When the backlight is an edge light, the backlight includes a light guide plate.

In the following, a method of producing the liquid crystal display device of Embodiment 1 is described.

The liquid crystal panel 40 is produced through conventionally known steps such as a TFT substrate production step (e.g., electrode, line, and TFT forming steps, an alignment film forming step), a CF substrate production step (e.g., a CF forming step, an alignment film forming step), a substrate assembling step, and a liquid crystal injecting step. The liquid crystal panel 40 is secured away from the backlight and the side wall 60F of the housing with a jig or the like so as not to bring the liquid crystal panel 40 into contact with the backlight and the side wall 60F of the housing holding the backlight. A fluid, uncured resin is poured via multiple holes 60H for pouring a resin provided in the side wall 60F of the housing, and the resin is cured at room temperature to adhesively secure the edge of the liquid crystal panel 40 to the side wall 60F of the housing. This produces the liquid crystal display device 70. Curing the resin at room temperature as in Embodiment 1 substantially eliminates deflection due to heat shrinkage of the components of the liquid crystal display device. The resin may be simultaneously or sequentially poured via multiple holes 60H for pouring a resin. The (1) groove 60G for holding a resin and the (2) holes 60H for pouring a resin provided in the side wall 60F of the housing make it possible to adhesively secure the edge of the liquid crystal panel 40 to the side wall 60F of the housing with the resin in a simple and suitable manner.

### Embodiment 2

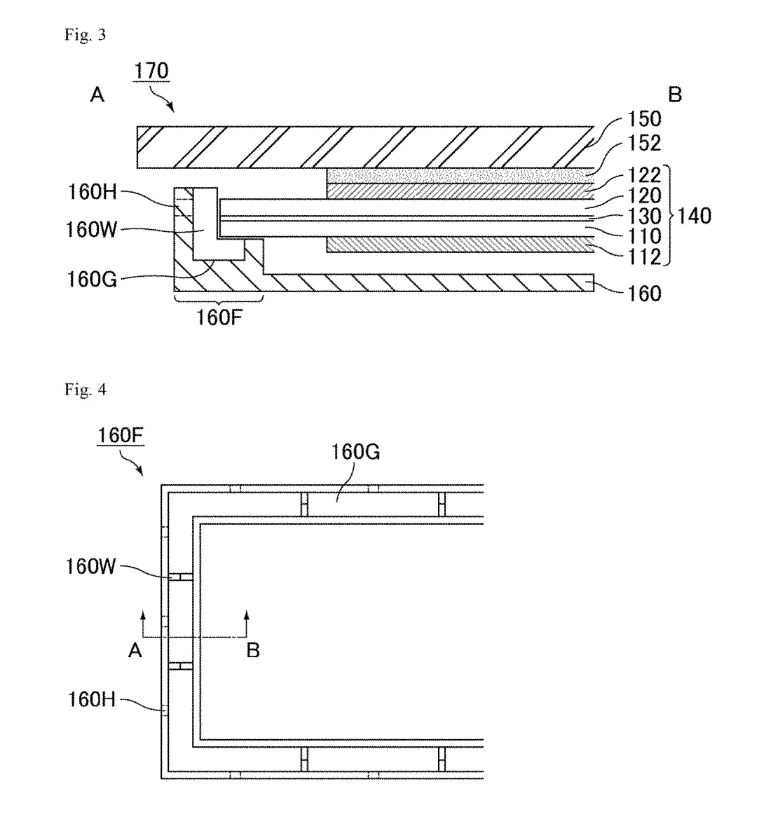

FIG. 3 is a schematic cross-sectional view of a liquid crystal display device of Embodiment 2. FIG. 4 is a schematic front view of a backlight unit of the liquid crystal display device of Embodiment 2. Here, FIG. 3 is a cross-sectional view taken along a dot-and-dash line A-B in FIG. 4.

In the liquid crystal display device of Embodiment 2, separation walls (partition walls 160W) are provided in a groove 160G for holding a resin in a side wall 160F of the housing. Preferably, multiple partition walls 160W are provided. In the side wall 160F of the housing, preferably, each section partitioned by the partition walls 160W has at least one hole 160H for pouring a resin. When such a configuration is employed and the resin is poured into narrower spaces partitioned by the partition walls 160W instead of a wider space, the resin is more likely to be uniformly contained in the groove 160G for holding a resin, so that the effects of the present invention can be more remarkably exerted. Though the cured resin is omitted for clarity in FIG. 3, the cured resin is disposed in a similar manner as in other embodiments, and the edge of the liquid crystal panel 140, the side wall 160F of the housing, and the periphery of a front plate 150 are adhesively secured to each other.

Other features of the liquid crystal display device of Embodiment 2 are the same as those of the liquid crystal display device of Embodiment 1 described above.

### Embodiment 3 and Modified Example Thereof

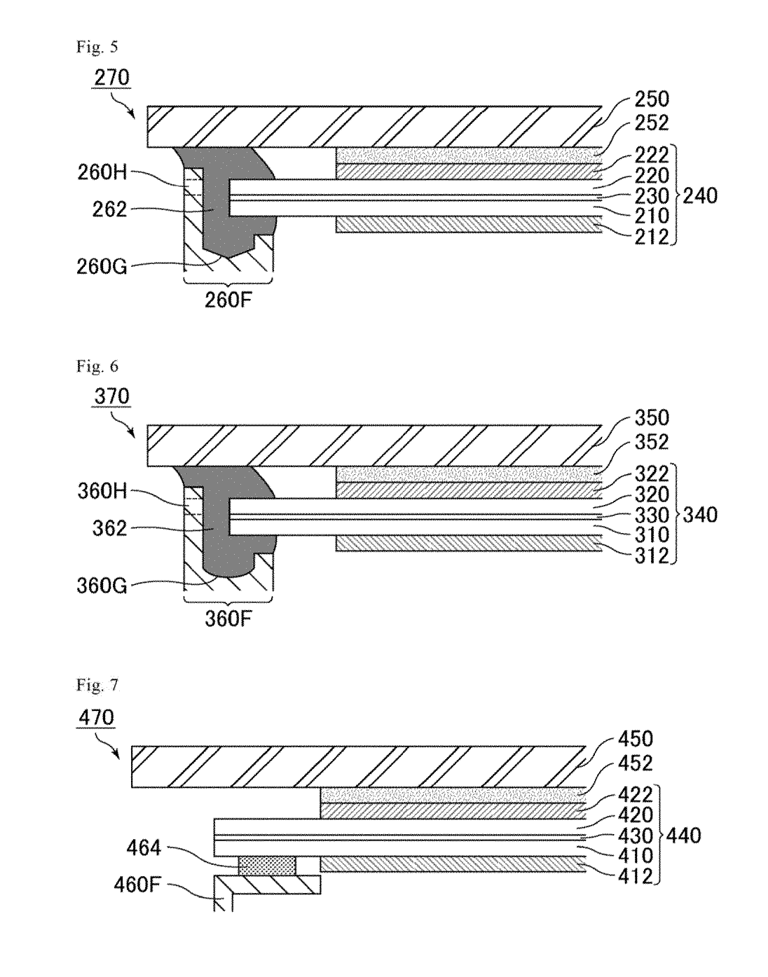

FIG. 5 is a schematic cross-sectional view of a liquid crystal display device of Embodiment 3. FIG. 6 is a schematic cross-sectional view of a liquid crystal display device of a modified example of Embodiment 3.

In the liquid crystal display devices of Embodiment 3 and a modified example thereof, grooves 260G and 360G for holding a resin provided in the side walls 260F and 360F of the housings each have a recessed bottom instead of a flat bottom. The groove 260G for holding a resin has a V-shaped bottom in a cross section viewed in the longitudinal direction of the groove. The groove 360G for holding a resin has a U-shaped bottom in a cross section viewed in the longitudinal direction of the groove. With such a recessed bottom of the groove for holding a resin, the resin is likely to be uniformly contained in the groove for holding a resin, so that the effects of the present invention can be more remarkably exerted.

Other features of the liquid crystal display devices of Embodiment 3 and the modified example thereof are the same as those of the liquid crystal display device of Embodiment 1.

### Embodiment 4 and Modified Example Thereof

FIG. 7 is a schematic cross-sectional view of a liquid crystal display device of Embodiment 4. FIG. 7 shows a portion received by cushion tape 464. In a preferred configuration, the surface of the cushion tape 464 facing the side wall 460F of the housing is adhesive so that the cushion tape 464 is bonded to the side wall 460F, but the surface facing the liquid crystal panel 440 is not adhesive. In cases where the liquid crystal panel 440 is separated for rework after the backlight unit is assembled with the liquid crystal panel 440, it is more convenient that the cushion tape remains on the side wall 460F of the housing, not the expensive liquid crystal panel 440.

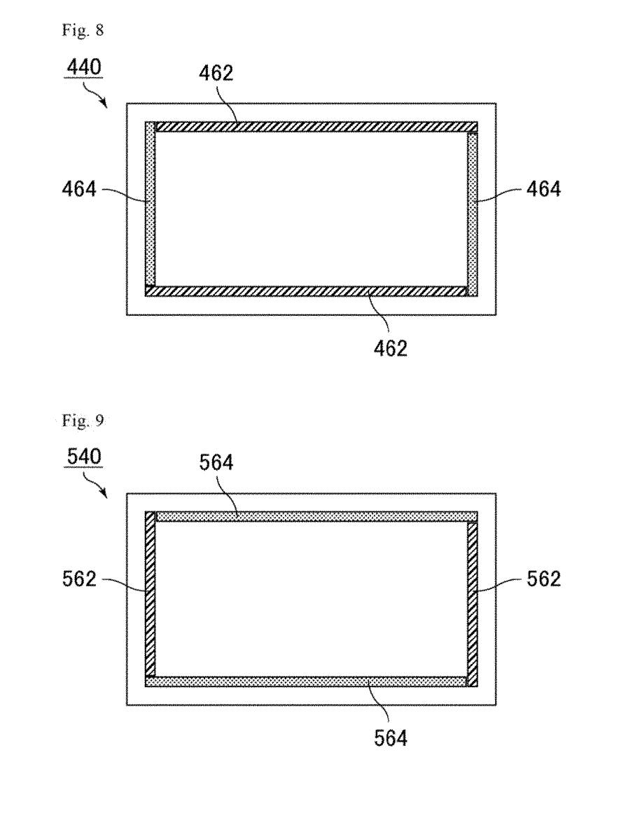

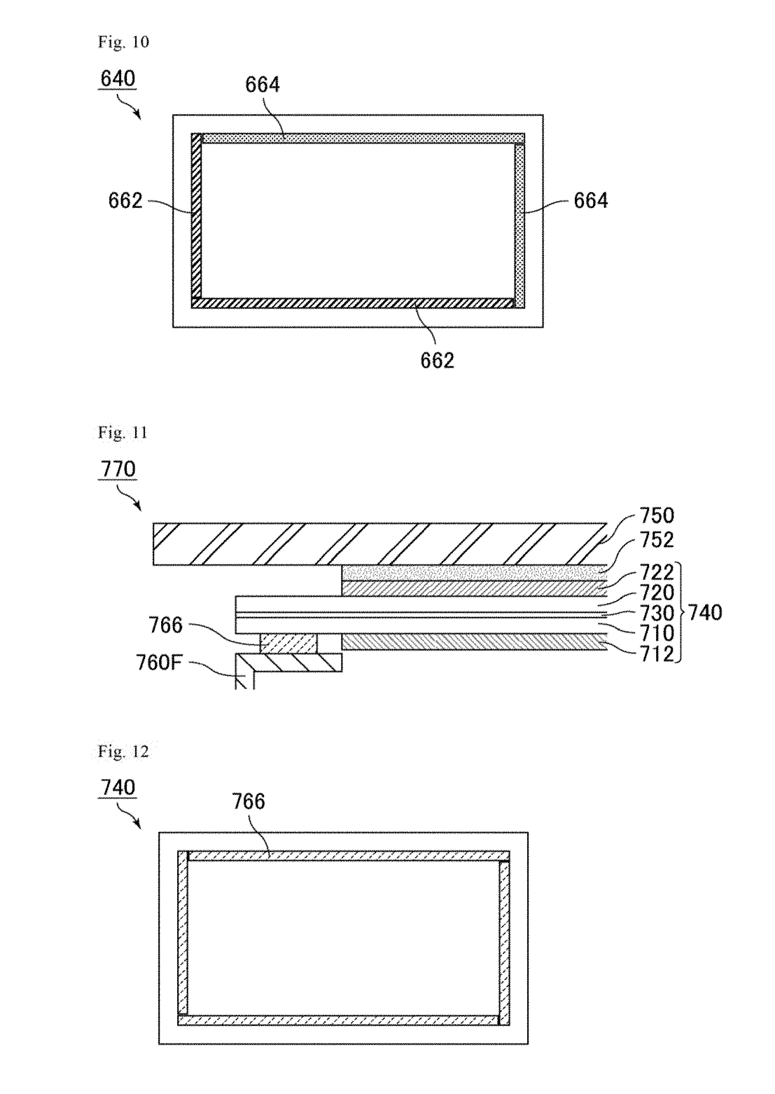

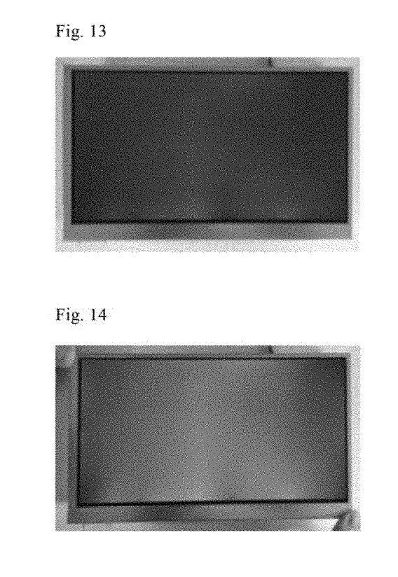

FIG. 8 is a schematic front view of the liquid crystal display device according to Embodiment 4. FIG. 9 is a schematic front view of a liquid crystal display device according to a first modified example of Embodiment 4. FIG. 10 is a schematic front view of a liquid crystal display device according to a second modified example of Embodiment 4, Each of FIGS. 8 to 10 shows the positions of the cured resin and the cushion tape. In the liquid crystal display devices of Embodiment 4 and the modified examples thereof, not all the four sides of the liquid crystal panel are adhesively secured with the cured resin. Instead, two of the four sides are adhesively secured with the cured resin, and the other two sides are received by the cushion tape so as not to put a load on the liquid crystal panel. Also with such an arrangement, the effects of the present invention can be exerted. FIGS. 8, 9, and 10 show the following combinations (1) to (3), respectively.

(1) Two long sides of a liquid crystal panel 440 are adhesively secured with a cured resin 462, and two short sides thereof are received by cushion tape 464 (FIG. 8).

(2) Two short sides of a liquid crystal panel 540 are adhesively secured with a cured resin 562, and two long sides thereof are received by cushion tape 564 (FIG. 9).

(3) A pair of a long side and a short side of a liquid crystal panel 640 is adhesively secured with a cured resin 662, and the diagonal pair of a long side and a short side is received by cushion tape 664 (FIG. 10).

The cushion tape at least includes a cushion layer and a pressure-sensitive adhesive layer. The cushion layer may include, for example, polyurethane foam or polyethylene foam. The pressure-sensitive adhesive layer may contain, for example, an acrylic pressure-sensitive adhesive or a urethane pressure-sensitive adhesive. Examples of the cushion tape include appropriate commercial one-sided tapes.

In one preferable embodiment, two sides of the liquid crystal panel are adhesively secured with a cured resin, and the other two sides are received by cushion tape so as not to put a load on the liquid crystal panel; however, it is sufficient that at least part of the edge of the liquid crystal panel 440 and at least part of the side wall of the housing are adhesively secured to each other with a cured resin and a cushioning material is disposed between another part of the edge of the liquid crystal panel and another part of the side wall of the housing. For example, one side of the liquid crystal panel may be adhesively secured to the side wall of the housing with a resin, and the other three sides may be received by cushion tape so as not to put a load on the liquid crystal panel. Alternatively, three sides of the liquid crystal panel may be adhesively secured to the side wall of the housing with a resin, and the other side may be received by cushion tape so as not to put a load on the liquid crystal panel. When a groove is provided in the side wall of the housing, the groove may be provided only in the side to be secured with the cured resin.

### Comparative Example 1

FIG. 11 is a schematic cross-sectional view of a liquid crystal display device of Comparative Example 1. FIG. 12 is a schematic front view of the liquid crystal display device of Comparative Example 1.

Typically, as shown in FIG. 11, a liquid crystal panel 740 is secured to a backlight by bonding the four-sides of the liquid crystal panel 740 to the side wall 760F of the housing with double-sided tape 766. In such a configuration, if the side wall 760F of the housing holding the backlight has a low flatness (has deflection), the liquid crystal panel 740 is deflected, causing light leakage in black display and thus reducing the contrast. Especially in IPS mode liquid crystal panels, a slight deflection (about 0.1 mm) causes light leakage in black display and reduces the contrast.

Examples of the liquid crystal display device of the present invention include in-vehicle units (e.g., automotive navigation systems), electronic books, digital photo frames, industrial equipment, televisions, personal computers, smartphones, and tablet computers.

The present invention is preferably applied to IPS mode liquid crystal display devices. This sufficiently prevents a reduction in the contrast due to the deflection of the liquid crystal panel that is likely to occur in the IPS mode liquid crystal display devices.

The configuration of the liquid crystal display device of the present invention can be confirmed by disassembling the liquid crystal display device and observing the appearance.

### REFERENCE SIGNS LIST

10, 110, 210, 310, 410, 710: TFT substrate
12, 22, 112, 122, 212, 222, 312, 322, 412, 422, 712, 722: polarizing plate
20, 120, 220, 320, 420, 720: CF substrate
30, 130, 230, 330, 430, 730: liquid crystal layer
40, 140, 240, 340, 440, 540, 640, 740: liquid crystal panel
50, 150, 250, 350, 450, 750: front plate
60F, 160F, 260F, 360F, 460F, 560F, 660F, 760F: side wall of housing
60H, 160H, 260H, 360H: holes for pouring a resin
60G, 160G, 260G, 360G: groove for holding a resin
62, 262, 362, 462, 562, 662: cured resin
70, 170, 270, 370, 470, 770: liquid crystal display device
160: housing of backlight
160W: partition wall
464, 564, 664: cushion tape
766: double-sided tape

1. A liquid crystal display device comprising:
a liquid crystal panel; and
a backlight unit including a backlight and a housing holding the backlight,
the backlight being positioned on the back face side of the liquid crystal panel such that the backlight does not make contact with the liquid crystal panel and overlaps the liquid crystal panel in a plan view,
the housing including a side wall,
the side wall surrounding the liquid crystal panel in a plan view,
at least part of an edge of the liquid crystal panel and at least part of the side wall of the housing being adhesively secured to each other with a cured resin.

2. The liquid crystal display device according to claim 1, further comprising a front plate,
at least part of a periphery of the front plate being adhesively secured with the cured resin.

3. The liquid crystal display device according to claim 1,
wherein at least part of the side wall of the housing includes a groove, and
at least part of the cured resin is contained in the groove.

4. The liquid crystal display device according to claim 3,
wherein the side wall of the housing includes a partition wall that partitions the groove.

5. The liquid crystal display device according to claim 3,
wherein the groove has a recessed bottom.

6. The liquid crystal display device according to claim 1,
wherein part of the edge of the liquid crystal panel and part of the side wall of the housing are adhesively secured to each other with the cured resin, and
a cushioning material is disposed between another part of the edge of the liquid crystal panel and part of the housing.

7. A method of producing the liquid crystal display device according to claim 1, the method comprising the steps of:
while holding a liquid crystal panel and a backlight without bringing the liquid crystal panel and the backlight into contact with each other, disposing an uncured resin between at least part of an edge of the liquid crystal panel and at least part of a side wall of a housing; and
curing the resin to adhesively secure the at least part of the edge of the liquid crystal panel and the at least part of the side wall of the housing to each other.

8. The method of producing the liquid crystal display device according to claim 7,
wherein the step of disposing the resin comprises pouring the resin into a groove provided in at least part of the side wall of the housing via a hole provided in the side wall of the housing.
